(19) United States
(12) Patent Application Publication
(10) Pub. No.: US 2019/0054646 A1
(43) Pub. Date: Feb. 21, 2019

(54) CUTTING DEVICE WITH A COMPRESSION WHEEL

(71) Applicant: THE BOEING COMPANY, Chicago, IL (US)

(72) Inventors: Curtis L. Hall, JR., Moncks Corner, SC (US); Jeffrey Lee Sherman, Pinopolis, SC (US); Neil Adams Alexander, Edisto Island, SC (US)

(21) Appl. No.: 15/680,163

(22) Filed: Aug. 17, 2017

(51) Int. Cl. B26D 7/14; B26D 7/08; B26D 7/26; B26D 5/04; B26D 7/20; B26D 1/04

(52) U.S. Cl. CPC B26D 7/14; B26D 7/088; B26D 7/2614; B26D 1/045; B26D 5/04; B26D 7/20; B26D 7/2628

(57) ABSTRACT

An apparatus for cutting a substrate includes a cutter head body. The cutter head body has a first portion and a second portion that is removably coupled to the first portion for securing a cutting blade between the first portion and the second portion. The apparatus also includes a pair of rollers coupled to the first portion and a compression wheel coupled to the cutter head body and aligned with the cutting blade for compressing the substrate prior to cutting.

### FIELD OF THE DISCLOSURE

The present disclosure relates to a cutting device.

### BACKGROUND

Cutting a substrate (e.g., a paper, wax paper, plastic, etc.) can be a time consuming process that causes physical fatigue (e.g., hand, wrist, back, and lower-body fatigue) and other ergonomic issues. For example, to cut a piece of the substrate, a technician rolls the substrate onto a cutting surface. After the substrate is rolled onto the cutting surface, the technician walks to one side of the cutting surface and cuts a portion of the substrate with a blade. Then, to complete the cut, the technician walks to the other side of the cutting surface and cuts a remaining portion of the substrate with the blade. To cut another piece of the substrate, the technician repeats the above-described process. Performing numerous iterations of the above-described process to cut multiple pieces of the substrate may cause physical fatigue. For example, hand and wrist fatigue may occur as a result of performing numerous cuts with the blade, back fatigue may occur as a result of leaning over the cutting surface to perform the cuts, and lower-body fatigue may occur as a result of walking around the cutting surface. Additionally, because each piece of the substrate is cut by hand, the accuracy (e.g., the smoothness) of the cuts may be subject to human error.

### SUMMARY

According to one implementation, an apparatus for cutting a substrate includes a cutter head body. The cutter head body has a first portion and a second portion that is removably coupled to the first portion for securing a cutting blade between the first portion and the second portion. The apparatus also includes a pair of rollers coupled to the first portion and a compression wheel coupled to the cutter head body and aligned with the cutting blade for compressing the substrate prior to cutting.

According to another implementation, a method of cutting a substrate includes supporting the substrate on a cutting mat and lowering a cutting device onto the substrate and the cutting mat using a driving mechanism. The cutting device includes a cutter head body. The cutter head body has a first portion and a second portion removably coupled to the first portion for securing a cutting blade between the first portion and the second portion. The cutting device also includes a pair of rollers coupled to the first portion and a compression wheel coupled to the cutter head body and aligned with the cutting blade for compressing the substrate prior to cutting. The method further includes driving the cutting device across the substrate and the cutting mat to cut the substrate.

One advantage of the above-described implementations is that a cutting device may cut multiple pieces of a substrate to reduce (or eliminate) physical fatigue of technicians. For example, the cutting device includes a cutting blade that is located between a compression wheel (e.g., a front wheel) and a pair of rolling devices (e.g., a pair of rear wheels). The technician rolls the substrate onto a cutting mat and presses a button to initiate the cutting process. For example, when the button is pressed, a pneumatic cylinder lowers the cutting device onto the cutting mat, and a motor drives the cutting device across the cutting mat to cut a piece of the substrate. While the cutting device is driven across the cutting mat, for a substantially smooth cut, the compression wheel applies pressure to the substrate before the cutting blade cuts the substrate. After the cut is complete, the pneumatic cylinder raises the cutting device from the cutting mat (e.g., the pneumatic cylinder resets) and the motor resets the position of the cutting device. To cut another piece of the substrate, the technician rolls more of the substrate onto the cutting mat and presses the button. Thus, multiple pieces of the substrate may be cut without the technician having to hand-cut the substrate and without the technician having to walk around the cutting mat. As a result, physical fatigue of the technician may be reduced. Additionally, the features, functions, and advantages that have been described can be achieved independently in various implementations or may be combined in yet other implementations, further details of which are disclosed with reference to the following description and drawings.

### BRIEF DESCRIPTION OF THE DRAWINGS

FIG. 1 depicts a cutting device having a compression wheel;

FIG. 2 depicts a bottom surface view of the cutting device of FIG. 1;

FIG. 3 depicts another view of the cutting device of FIG. 1;

FIG. 4 depicts a side view of the cutting device of FIG. 1;

FIG. 5 depicts separated components of the cutting device of FIG. 1;

FIG. 6 depicts separated components of the cutting device of FIG. 1;

FIG. 7 depicts separated components of the cutting device of FIG. 1;

FIG. 8 depicts a top surface view of the cutting device of FIG. 1;

FIG. 9 depicts a cutting machine that includes the cutting device of FIG. 1; and

FIG. 10 is a flowchart depicting a method of cutting a substrate.

### DETAILED DESCRIPTION

Particular embodiments of the present disclosure are described below with reference to the drawings. In the description, common features are designated by common reference numbers throughout the drawings.

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

The present disclosure describes a cutting device that cuts multiple pieces of a substrate to reduce (or eliminate) physical fatigue of technicians. For example, the cutting device includes a cutting blade that is located between a compression wheel (e.g., a front wheel) and a pair of rolling devices (e.g., a pair of rear wheels). The technician rolls the substrate onto a cutting mat and presses a button to initiate the cutting process. For example, when the button is pressed, a pneumatic cylinder lowers the cutting device onto the cutting mat, and a motor drives the cutting device across the cutting mat to cut a piece of the substrate. While the cutting device is driven across the cutting mat, for a substantially smooth cut, the compression wheel applies pressure to the substrate before the cutting blade cuts the substrate. For example, the compression wheel compresses a region of the substrate to be cut before the cutting blade cuts the substrate. According to some implementations, the substrate includes a liquid substance (e.g., a gel-like substance), and the compression wheel squeezes (e.g., forces) the liquid substance out of a cutting path of the cutting blade to reduce fouling of the cutting blade. After the cut is complete, the pneumatic cylinder raises the cutting device from the cutting mat (e.g., the pneumatic cylinder resets) and the motor resets the position of the cutting device. To cut another piece of the substrate, the technician rolls more of the substrate onto the cutting mat and presses the button. Thus, multiple pieces of the substrate may be cut without the technician having to hand-cut the substrate and without the technician having to walk around the cutting mat. As a result, physical fatigue of the technician may be reduced.

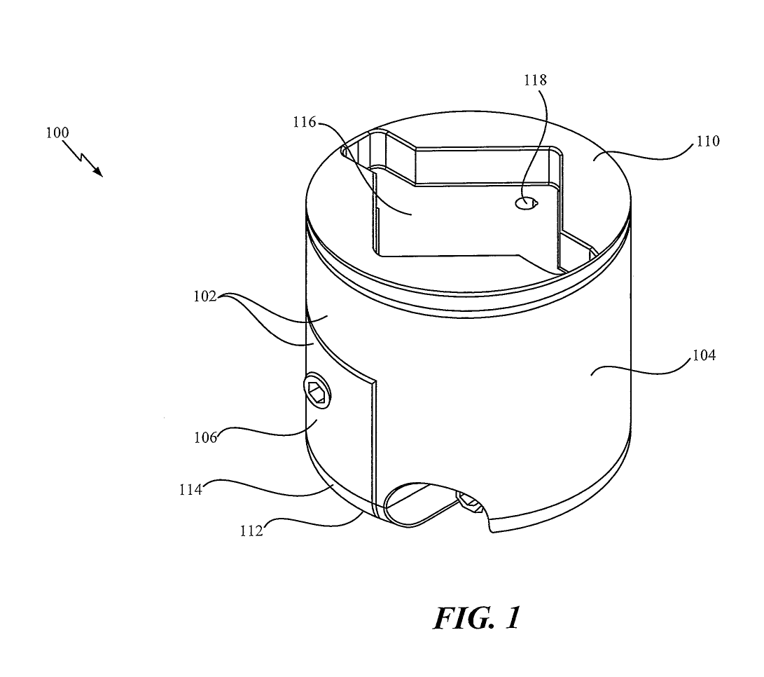

FIG. 1 depicts a cutting device 100 that is operable to cut a substrate. The cutting device includes a cutter head body 102. The cutter head body 102 includes a first portion 104 and a second portion 106. The second portion 106 is configured to couple to the first portion 104 to secure a cutting blade (not shown in FIG. 1) between the first portion 104 and the second portion 106. Thus, as described below, the second portion 106 may be decoupled (e.g., removed) from the first portion 104 to replace the cutting blade.

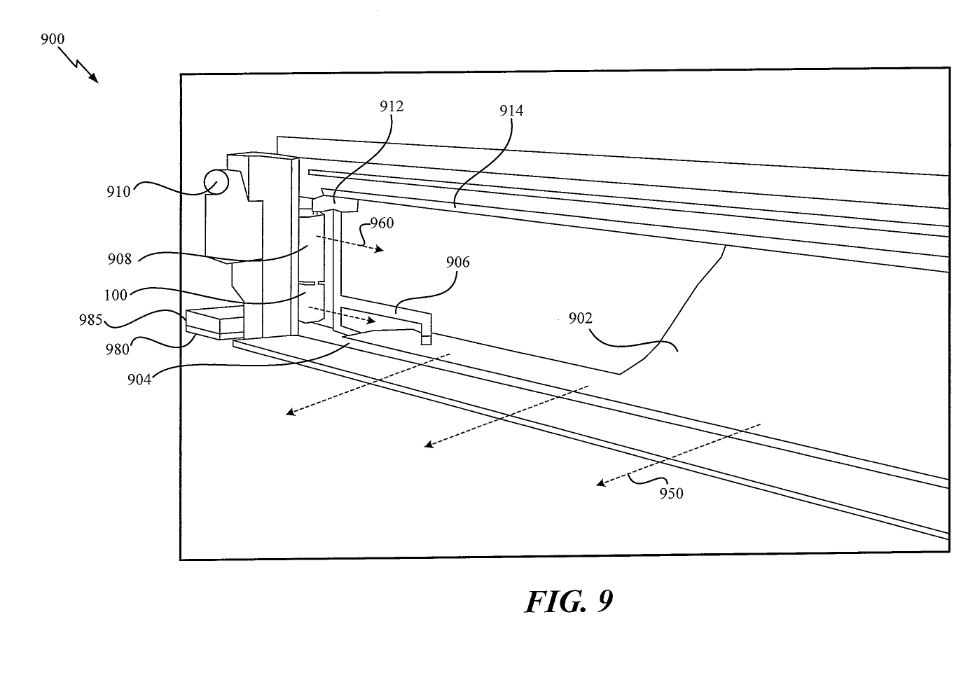

In the illustrative example of FIG. 1, the cutter head body 102 is substantially cylindrical. The cutter head body 102 includes a top surface 110 and a bottom surface 112. Edges of the bottom surface 112 are tapered to enable the cutter head body 102 to roll onto a substrate, such as a substrate 902 of FIG. 9, without substantially moving the substrate. For example, the bottom surface 112 includes tapered edges 114 such that, when wheels (e.g., a rollers) proximate to the bottom surface 112 roll up to a substrate, the cutter head body 102 can roll onto the substrate without pushing or tearing the substrate. The top surface 110 includes an indentation pattern 116 that is configured to secure to a pneumatic cylinder (not shown). For example, a pneumatic cylinder may be inserted into the indentation pattern 116 and coupled to the top surface 110 by screwing a screw through the pneumatic cylinder into a screw hole 118. As described below, the pneumatic cylinder may be configured to lower the cutting device 100 onto a cutting mat.

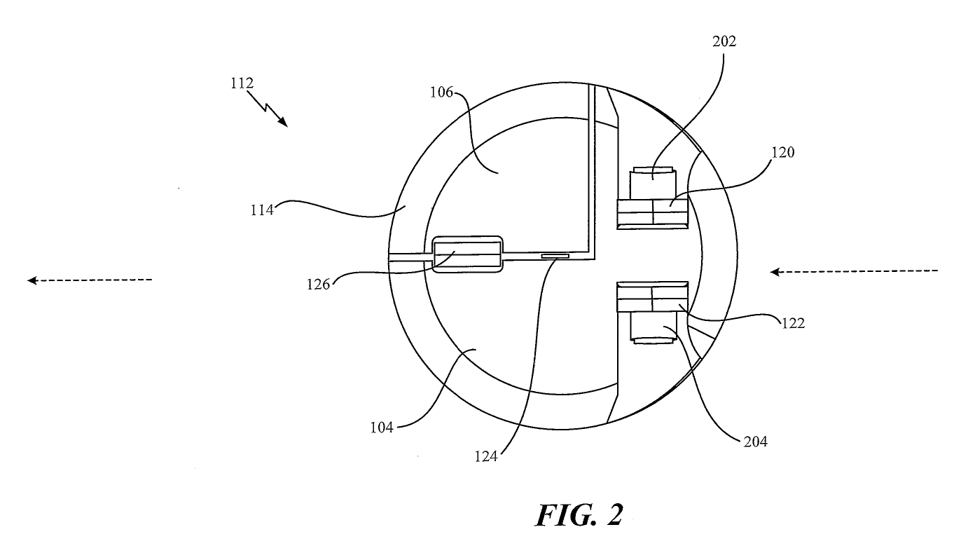

Referring to FIG. 2, the bottom surface 112 of the cutting device 100 is shown. A cutting blade 124 is illustrated when the cutting device 100 is viewed from the bottom surface 112. The cutting blade 124 is secured by the first portion 104 of the cutting device 100 and the second portion 106 of the cutting device 106. For example, the second portion 106 is configured to couple to the first portion 104 to secure the cutting blade 124.

A pair of rollers 120, 122 is also illustrated in FIG. 2. A roller device 120 is coupled to the first portion 104 of the cutting device 100 by a screw 202, and a roller device 122 is also coupled to the first portion 104 of the cutting device 100 by a screw 204. The rollers 120, 122 are used to move the cutting device 100 across the substrate.

A compression wheel 126 is also illustrated in FIG. 2. The compression wheel 126 is coupled to the first portion 104 of the cutting device 100. The compression wheel 126 is positioned at least partially between the first portion 104 and the second portion 106 of the cutting device 100. The position of the cutting blade 124 is between the compression wheel 126 and the pair of roller device 120, 122 to enable a smooth and controlled cut.

For example, as shown in FIG. 2, the cutting device 100 moves from right to left during operation. The compression wheel 126 and the pair of rollers 120, 122 move the cutting device 100 along a cutting mat towards the substrate to be cut. As the cutting device 100 approaches the substrate, the tapered edges 114 of the bottom surface 112 glides over the substrate and the compression wheel 126 rolls onto the substrate. As the compression wheel 126 rolls onto the substrate, the compression wheel smooths out the substrate and removes (e.g., eliminates) adhesive and moisture from the substrate to enable an unwrinkled (e.g., smooth) cut. For example, the compression wheel 126 applies pressure to the substrate prior to the cutting blade 124 cutting the substrate which may increase the stability of the cutting blade 124. To illustrate, the compression wheel 126 may compress a region of the substrate to be cut before the cutting blade 124 cuts the substrate. Compressing the region of the substrate to be cut may extend the lifetime of the cutting blade 124 (e.g., reduce fouling effects associated with the cutting blade 124). For example, the substrate may include a liquid substance (e.g., a gel-like substance), and the compression wheel 126 may squeeze the liquid substance out of a cutting blade path to reduce fouling of the cutting blade 124.

The rollers 120, 122 also assist the compression wheel 126 in moving the cutting device 100 from right to left. Because there are two rollers 120, 122 that are substantially symmetrical with the position of the compression wheel 126 and the position of the cutting blade 124, the rollers 120, 122 substantially stabilize the cutting device 100 during the cut such that the cut is relatively smooth and straight. Although three wheels (e.g., the compression wheel 126 and the rollers 120, 122) are illustrated in FIG. 2, in other implementations, the cutting device 100 may include more than three wheels.

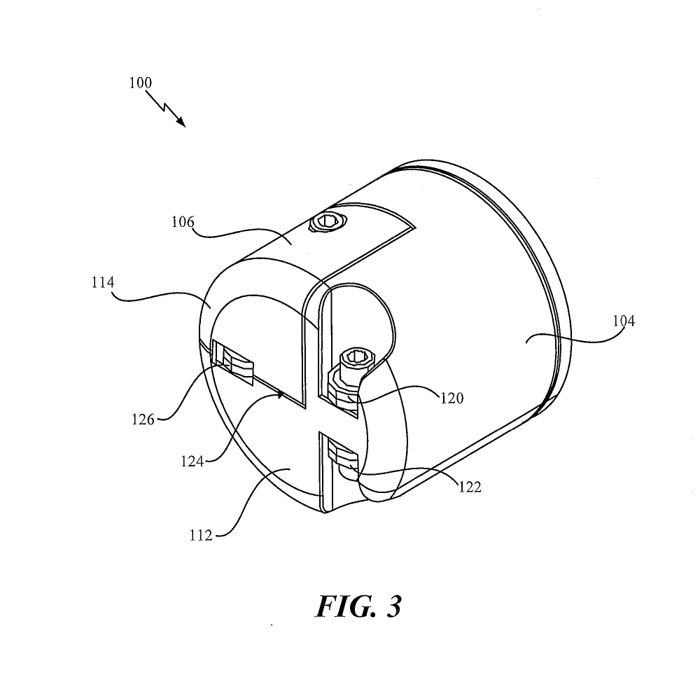

Referring to FIG. 3, another view of the cutting device 100 is shown. According to FIG. 3, the cutting blade 124 extends from the bottom surface 112 to cut the substrate as the compression wheel 126 and the rollers 120, 122 move along the substrate. According to one implementation, the cutting blade 124 extends further beyond the bottom surface 112 than the compression wheel 126 and the rollers 120, 122. As a result, the cutting blade 124 is able to perform a “deep” cut into the substrate. According to another implementation, the cutting blade 124 extends the same length beyond the bottom surface as the compression wheel 126 and the rollers 120, 122. As a result, the cutting blade is able to perform a “thin” cut into the substrate. The depth of the cutting blade 124 may be adjustable. For example, the depth of the cutting blade 124 may be manually adjustable by opening cutting device 100 (e.g., decoupling the first portion 104 from the second portion 106) and manually repositioning the cutting blade 124. Alternatively, the depth of the cutting blade 124 may be adjusted using a mechanism of the first portion 104 of the cutting device 100.

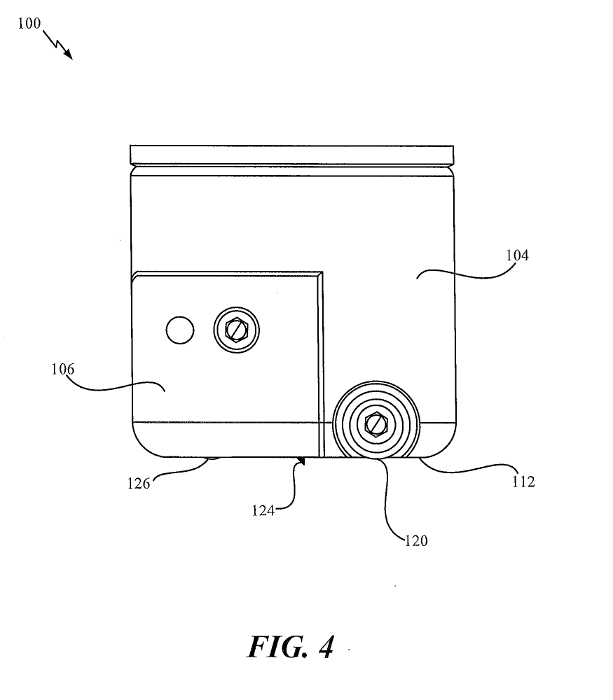

Referring to FIG. 4, another view of the cutting device 100 is shown. According to FIG. 4, the cutting blade 124 extends further beyond the bottom surface 112 than the compression wheel 126 and the roller device 120. Thus, the cutting blade 124 is able to perform a deep cut into the substrate.

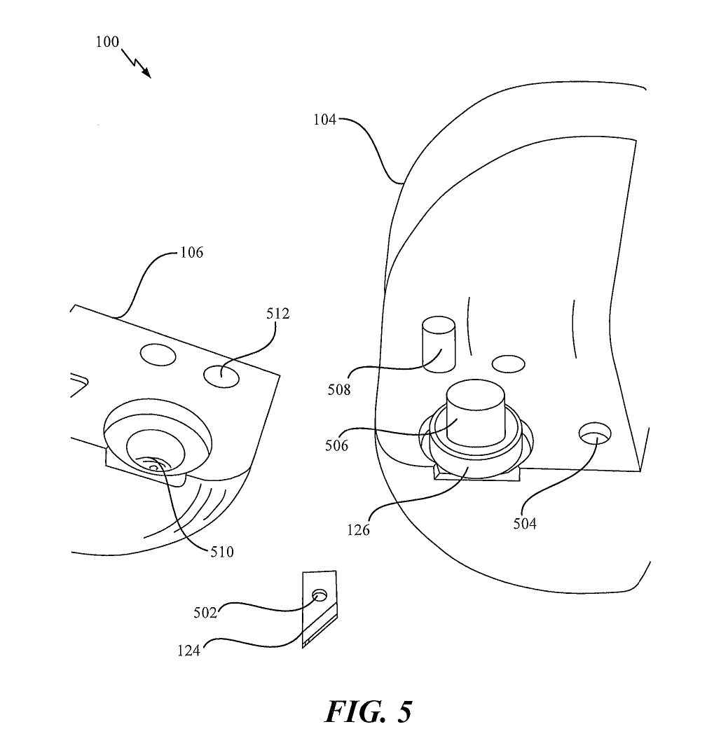

Referring to FIG. 5, separated components of the cutting device 100 are shown. For example, in FIG. 5, the first portion 104 of the cutter head body 102 is separated from the second portion 106 of the cutter head body 102, and the cutting blade 124 is decoupled from the first portion 104.

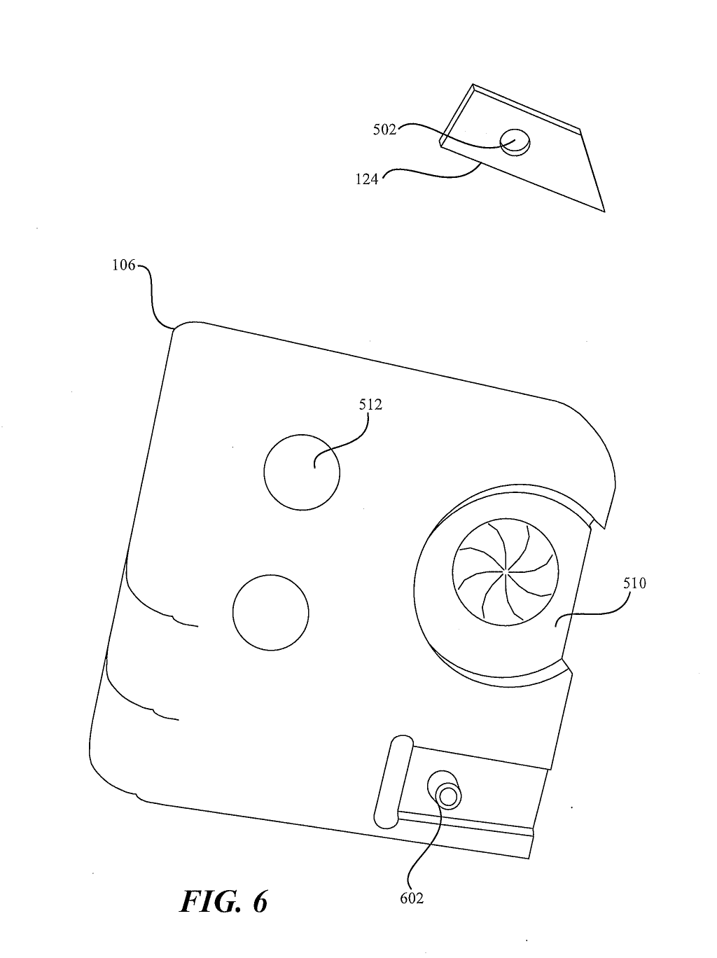

The cutting blade 124 includes a plug hole 502. To couple the cutting blade 124 to the first portion 104 of the cutter head body 102, the plug hole 502 is placed over a plug hole 504 in the first portion 104 of the cutter head body 102, and a plug (e.g., a plug 602 of FIG. 6 associated with the second portion 106) is inserted into the plug holes 502, 504.

The compression wheel 126 is placed onto a plug 506 of the first portion 104. To couple the first portion 104 of the cutter head body 102 to the second portion 106 of the cutter head body 102, the plug 506 is inserted into a plug hole 510 of the second portion 106, and a plug 508 is inserted into a plug hole 512. Additionally, the compression wheel 126 may include or be assembled with other parts (not shown). For example, the compression wheel 126 may be assembled with an axle, wheel bearings, etc.

Referring to FIG. 6, the cutting blade 124 and the second portion 106 of the cutter head body 102 is shown. The second portion 106 of the cutter head body 102 includes the plug 602 that is configured to couple the cutting blade 124 to each portion 104, 106 of the cutter head body 102. For example, to couple and secure the cutting blade between the first and second portions 104, 106, the plug 602 is inserted into the plug hole 502 of the cutting blade 124 and into the plug hole of the 504 of the first portion 104. According to another implementation, the plug 602 is built into the first portion 104 (or the second portion 106) and plug hole 502 of the cutting blade 124 is slid over the plug 602. According to another implementation, the cutting blade 124 may be secured to the cutting device 100 using other components. For example, the cutting blade 124 may be secured using a notch in cutting blade 124, etc.

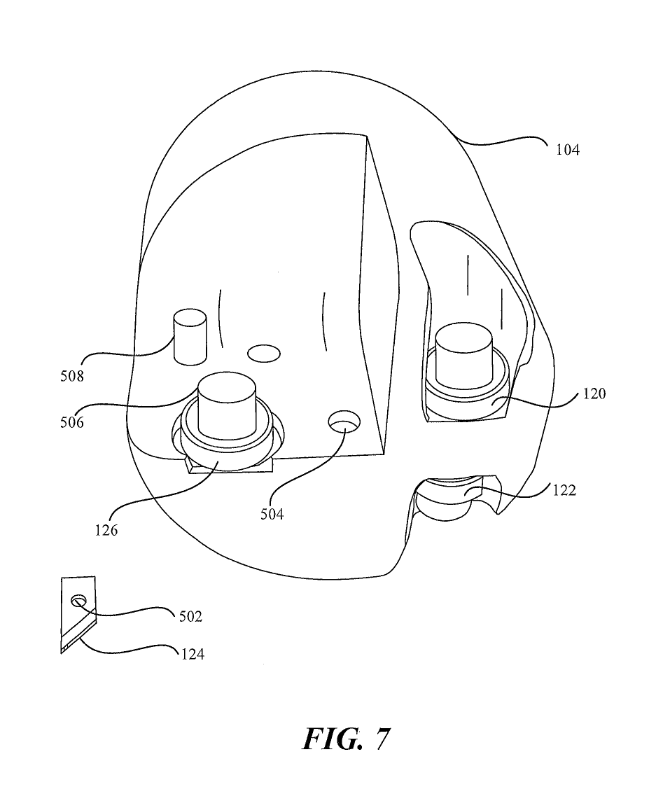

Referring to FIG. 7, the cutting blade 124 and the first portion 104 of the cutter head body 102 is shown. The plug hole 502 is placed over the plug hole 504, and the plug 602 is inserted into the plug holes 502, 504 to couple the first portion 104 to the second portion 106 and to secure the cutting blade 124 between each portion 104, 106. The rollers 120, 122 may include or be assembled with other parts. For example, the rollers 120, 122 may be assembled with axles, wheel bearings, etc.

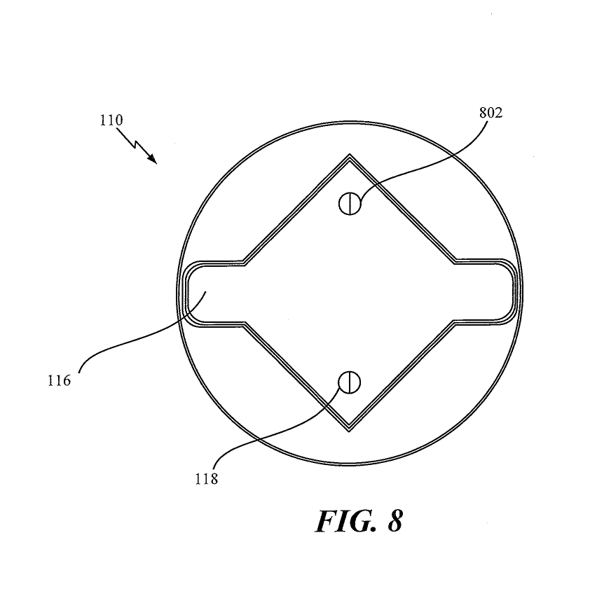

Referring to FIG. 8, the top surface 110 of the cutter head body 102 is shown. The top surface 110 includes the indentation pattern 116 that is configured to secure to the pneumatic cylinder (not shown). For example, a pneumatic cylinder may be inserted into the indentation pattern 116 and coupled to the top surface 110 by screwing a screw through the pneumatic cylinder into the screw hole 118 and a screw hole 802. As described below, the pneumatic cylinder may be configured to lower the cutting device 100 onto a cutting mat.

Referring to FIG. 9, a system 900 for cutting a piece of substrate using a cutting device with a compression wheel is shown.

In FIG. 9, a substrate 902 is resting on a cutting mat 904. According to one implementation, the cutting mat 904 is comprised of a polymeric material. A technician may pull the substrate 902 across the cutting mat 904 in the direction of the arrows 950. After a desired amount of the substrate 902 is pulled across the cutting mat 904, the technician (or a controller) may engage a substrate holder 906 to hold the substrate 902 in place.

The cutting device 100 of FIG. 1 is coupled to the pneumatic cylinder 908. For example, the pneumatic cylinder 908 is inserted into the indentation pattern 116 of the top surface 110 of the cutting device 100. Screws are inserted (and screwed) through the pneumatic cylinder 908 and the screw holes 118, 802 to couple the pneumatic cylinder 908 to the cutting device 100. A top portion of the pneumatic cylinder 908 is coupled to a sliding component 912 of the system 900. The sliding component 912 is configured to be driven across an arm 914 of the system 900 by a motor 910. For example, the motor 910 may drive the sliding component 912 across the arm 914 in the direction of the arrows 960. According to one implementation, the motor 910 is a direct-current (DC) motor.

During operation, the technician may press a button (or perform another action) to initiate the cutting process at a controller 985. When the cutting process is initiated, the pneumatic cylinder 908 may lower the cutting device 100 onto the cutting mat 904. For example, the pneumatic cylinder 908 may lower the cutting device 100 such that the compression wheel 126 and the rollers 120, 122 are touching the cutting mat 904. After the pneumatic cylinder 908 lowers the cutting device 100 onto the cutting mat 904, the motor 910 drives the sliding component 912, and thus pneumatic cylinder 908 and the cutting device 100, across the arm 914 in the direction of the arrows 960.

When the cutting device 100 is driven in the direction of the arrows 960, the compression wheel 126 and the pair of rollers 120, 122 move the cutting device 100 along the cutting mat 904 towards the substrate 902 to be cut. As the cutting device 100 approaches the substrate 902, the tapered edges 114 of the bottom surface 112 glide over the substrate 902 and the compression wheel 126 rolls onto the substrate 902. As the compression wheel 126 rolls onto the substrate 902, the compression wheel 126 smooths out the substrate 902 and removes (e.g., eliminates) adhesive and moisture from the substrate 902 to enable an unwrinkled (e.g., smooth) cut. For example, the compression wheel 126 applies pressure to the substrate 902 prior to the cutting blade 124 cutting the substrate 902 which may increase the stability of the cutting blade 124. To illustrate, the compression wheel 126 may compress a region of the substrate 902 to be cut before the cutting blade 124 cuts the substrate 902. Compressing the region of the substrate 902 to be cut may extend the lifetime of the cutting blade 124 (e.g., reduce fouling effects associated with the cutting blade 124). For example, the substrate 902 may include a liquid substance (e.g., a gel-like substance), and the compression wheel 126 may squeeze the liquid substance out of a cutting blade path to reduce fouling of the cutting blade 124.

The rollers 120, 122 also assist the compression wheel 126 in moving the cutting device 100 from right to left. Because there are two rollers 120, 122 that are substantially symmetrical with the position of the compression wheel 126 and the position of the cutting blade 124, the rollers 120, 122 substantially stabilize the cutting device 100 during the cut such that the cut is relatively smooth and straight.

After the cut is complete, the pneumatic cylinder 908 raises the cutting device 100 from the cutting mat 904, and the motor 910 resets the position of the sliding component 912 for another cut. The technician may pull more of the substrate 902 over the cutting mat 904 and press the button to initiate another cut.

According to FIG. 9, the system 900 also includes a sensor device 980. The sensor device 980 may be configured to detect movement proximate to the cutter head body 102 (e.g., the cutting device 100). The sensor device 980 may generate a stop signal in response to detection of movement. The motor 910 may be halted in response to generation of the stop signal. For example, the controller 985 may be responsive to the sensor device 980 (e.g., responsive to the stop signal) and may halt operation of the motor 910. Thus, the sensor device 980 may be a safety measure to ensure that the system 900 is not operating if somebody is near the cutting device 100. According to one implementation, the sensor device 980 may include a floor mat that detects whether somebody is standing near the cutting device 100.

Thus, the system 900 may enable multiple pieces of the substrate 902 to be cut while reducing (or eliminating) physical fatigue of technicians. For example, the cutting device 100 includes the cutting blade 124 that is located between the compression wheel 126 (e.g., a front wheel) and the pair of rolling devices 120, 122 (e.g., a pair of rear wheels). The technician rolls the substrate 902 onto the cutting mat 902 and presses a button to initiate the cutting process. For example, when the button is pressed, the pneumatic cylinder 908 lowers the cutting device 100 onto the cutting mat 904, and the motor 910 drives the cutting device 100 across the cutting mat 904 to cut a piece of the substrate 902. While the cutting device 100 is driven across the cutting mat 904, for a substantially smooth cut, the compression wheel 126 applies pressure to the substrate 902 before the cutting blade 124 cuts the substrate 902. For example, the compression wheel 126 may compress the region of the substrate 902 to be cut before the cutting blade 124 cuts the substrate 902. Compressing the region of the substrate 902 to be cut may extend the lifetime of the cutting blade 124 (e.g., reduce fouling effects associated with the cutting blade 124). For example, the substrate 902 may include a liquid substance (e.g., a gel-like substance), and the compression wheel 126 may squeeze the liquid substance out of a cutting blade path to reduce fouling of the cutting blade 124 by removing potential contaminating liquids.

After the cut is complete, the pneumatic cylinder 908 raises the cutting device 100 from the cutting mat 904 (e.g., the pneumatic cylinder resets) and the motor 910 resets the position of the cutting device 910. To cut another piece of the substrate 902, the technician rolls more of the substrate 902 onto the cutting mat 904 and presses the button. Thus, multiple pieces of the substrate 902 may be cut without the technician having to hand-cut the substrate 902 and without the technician having to walk around the cutting mat 904 to cut along the entire substrate 902. As a result, physical fatigue of the technician may be reduced.

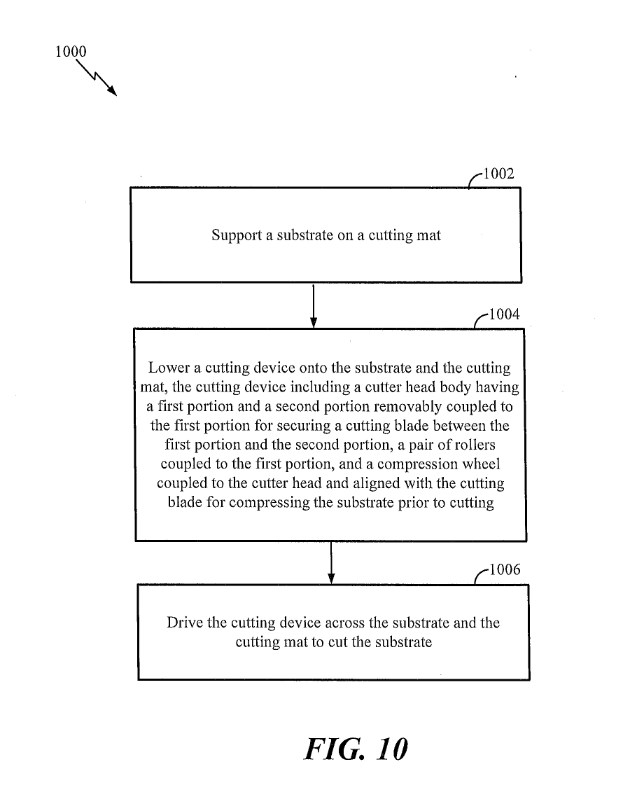

Referring to FIG. 10, a method 1000 for cutting a substrate is shown. The method 1000 is performed by the system 900 of FIG. 9. In particular, the system 900 uses the cutting device 100 of FIG. 1 to perform the method 1000.

The method 1000 includes supporting a substrate on a cutting mat, at 1002. For example, the substrate holder 906 may support the substrate 902 on the cutting mat 904.

The method 1000 includes lowering a cutting device onto a cutting mat using a pneumatic cylinder, at 1004. For example, referring to FIG. 9, the pneumatic cylinder 908 may lower the cutting device 100 onto the cutting mat 904. The cutting device 100 includes the cutting blade 124 and the cutter head body 102. The cutter head body 102 includes the first portion 104 and the second portion 106 that is configured to couple to the first portion 104 to secure the cutting blade 124 between the first portion 104 and the second portion 106. The cutting device 100 also includes the pair of rollers 120, 122 coupled to the first portion 106. The cutting device 100 further includes the compression wheel 126 positioned at least partially between the first portion 104 and the second portion 106. The position of the cutting blade 124 is between the compression wheel 126 and the pair of rollers 120, 122.

The method 1000 also includes driving the cutting device across the cutting mat and the substrate using a motor to cut the substrate, at 1006. For example, referring to FIG. 9, the motor drives the sliding component 912, and thus pneumatic cylinder 908 and the cutting device 100, across the arm 914 in the direction of the arrows 960. When the cutting device 100 is driving in the direction of the arrows 960, the compression wheel 126 and the pair of rollers 120, 122 move the cutting device 100 along the cutting mat 904 towards the substrate 902 to be cut. As the cutting device 100 approaches the substrate 902, the tapered edges 114 of the bottom surface 112 glides over the substrate 902 and the compression wheel 126 rolls onto the substrate 902. As the compression wheel 126 rolls onto the substrate 902, the compression wheel 126 smooths out the substrate 902 and removes (e.g., eliminates) adhesive and moisture from the substrate 902 to enable an unwrinkled (e.g., smooth) cut. For example, the compression wheel 126 applies pressure to the substrate 902 prior to the cutting blade 124 cutting the substrate 902 which may increase the stability of the cutting blade 124. The rollers 120, 122 also assist the compression wheel 126 in moving the cutting device 100 from right to left. Because there are two rollers 120, 122 that are substantially symmetrical with the position of the compression wheel 126 and the position of the cutting blade 124, the rollers 120, 122 substantially stabilize the cutting device 100 during the cut such that the cut is relatively smooth and straight.

Thus, the method 1000 of FIG. 10 may enable multiple pieces of the substrate 902 may be cut without the technician having to hand-cut the substrate 902 and without the technician having to walk around the cutting mat 904 to cut along the entire substrate 902. As a result, physical fatigue of the technician may be reduced.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

The steps of a method or algorithm described in connection with the implementations disclosed herein may be included directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal. A storage device is not a signal.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single implementation for the purpose of streamlining the disclosure. Examples described above illustrate but do not limit the disclosure. It should also be understood that numerous modifications and variations are possible in accordance with the principles of the present disclosure. As the following claims reflect, the claimed subject matter may be directed to less than all of the features of any of the disclosed examples. Accordingly, the scope of the disclosure is defined by the following claims and their equivalents.

What is claimed is:

1. An apparatus for cutting a substrate with a cutting blade, the apparatus comprising:
a cutter head body having a first portion and a second portion removably coupled to the first portion for securing the cutting blade between the first portion and the second portion;
a pair of rollers rotatably coupled to the first portion and disposed on either side of the cutting blade; and
a compression wheel coupled to the cutter head body and aligned with the cutting blade for compressing the substrate prior to cutting.

2. The apparatus of claim 1, wherein the compression wheel is coupled to at least one of the first portion and the second portion.

3. The apparatus of claim 1, wherein the cutter head body is substantially cylindrical and includes a top surface and a bottom surface spaced from the top surface, and wherein the cutting blade, the pair of rollers, and the compression wheel each extend from the bottom surface of the cutter head body.

4. The apparatus of claim 3, wherein the cutter head body further comprises a tapered edge adjacent to the bottom surface for providing clearance between the cutter head body and the substrate.

5. The apparatus of claim 3, wherein the cutting blade extends a greater distance beyond the bottom surface than the pair of rollers and the compression wheel.

6. The apparatus of claim 3, wherein the cutting blade, the pair of rollers, and the compression wheel extend a substantially equal distance beyond the bottom surface.

7. The apparatus of claim 3, wherein the top surface of the cutter head body includes a recess configured to accept a drive mechanism for raising and lowering the cutter head body.

8. The apparatus of claim 7, wherein the drive mechanism is further defined as a pneumatic cylinder and a motor configured to drive the pneumatic cylinder and the cutter head body.

9. The apparatus of claim 8, wherein the motor is further defined as a direct current motor.

10. The apparatus of claim 8, further comprising a sensor device configured to:
detect movement proximate to the cutter head body; and
generate a stop signal for halting the motor in response to detection of movement.

11. The apparatus of claim 1, further comprising a cutting mat for supporting the substrate, wherein the compression wheel and the pair of rollers are configured to guide the cutter head body across the substrate and the cutting mat.

12. A method of cutting a substrate with a cutting blade, the method comprising:
supporting the substrate on a cutting mat;
lowering a cutting device onto the substrate and the cutting mat, the cutting device comprising:
a cutter head body having a first portion and a second portion removably coupled to the first portion for securing the cutting blade between the first portion and the second portion;
a pair of rollers coupled to the first portion; and
a compression wheel coupled to the cutter head and aligned with the cutting blade for compressing the substrate prior to cutting; and
driving the cutting device across the substrate and the cutting mat to cut the substrate.

13. The method of claim 12, wherein the compression wheel is coupled to at least one of the first portion and the second portion.

14. The method of claim 12, wherein the cutter head body is substantially cylindrical and includes a top surface and a bottom surface spaced from the top surface, wherein the cutting blade, the pair of rollers, and the compression wheel each extend from bottom surface of the cutter head body.

15. The method of claim 14, wherein the cutter head body further comprises a tapered edge adjacent the bottom surface for providing clearance between the cutter head body and the substrate.

16. The method of claim 14, wherein the cutting blade extends a greater distance beyond the bottom surface than the pair of rollers and the compression wheel.

17. The method of claim 14, wherein the cutting blade, the pair of rollers, and the compression wheel extend a substantially equal distance beyond the bottom surface.

18. The method of claim 12, wherein the compression wheel compresses a region of the substrate to be cut before the cutting blade cuts the substrate.

19. The method of claim 12, further comprising engaging a substrate holder to hold the substrate in place before the cutting device engages the substrate.

20. The method of claim 12, wherein the substrate includes a liquid substance, and wherein the compression wheel squeezes the liquid substance out of a cutting blade path to reduce fouling of the cutting blade.
